(19) United States
(12) Patent Application Publication
(10) Pub. No.: US 2025/0210012 A1
(43) Pub. Date: Jun. 26, 2025

(54) MUSICAL INSTRUMENT COMPENSATION TECHNIQUE

(71) Applicant: Howard R Feiten, JR., Studio City, CA (US)

(72) Inventor: Howard R Feiten, JR., Studio City, CA (US)

(21) Appl. No.: 18/991,643

(22) Filed: Dec. 22, 2024

Related U.S. Application Data
(60) Provisional application No. 63/613,952, filed on Dec. 22, 2023.

(51) Int. Cl. G10D 3/14; G10D 1/08; G10D 3/04

(52) U.S. Cl. CPC G10D 3/14; G10D 1/085; G10D 3/04

(57) ABSTRACT

An intonation compensation assembly and method of a stringed musical instrument which provides improved intonation quality and stability by defining settings parameters and then fixing the parameters into a design fabrication of a compensated wrap-around bar for installation with a tremolo bridge. The fabricated design can be adjustable or nonadjustable. The fabricated assembly provides stability and simplification by eliminating and replacing multiple unstable parts with a single, repeatable, and stable part that provides repeatable string intonation qualities of the instrument as part of tuning requirements.

### BACKGROUND

Mechanical reliability problems associated with existing guitar bridge systems are well documented. The use of substandard and/or improperly specified mounting parts and assembly procedures introduces a significant degradation in intonation quality of the musical instrument at the “saddle” (a piece that typically rests on the bridge and under the strings near the bridge pins (the string anchor locations on the bridge)).

For example, improper screw design, threading, and a reduction in long-term “tightness” (the retention capability to retain a solid screw torque that overcomes unscrewing through many use situations during use of the instrument) can result in an unreliable and incremental decrease in saddle height adjustment, thereby affecting the intonation quality of the sound from the instrument. A change in string height of the saddle in turn changes the tension relationship between the strings and the tremolo springs (e.g., in a tremolo plate implementation) further resulting in an undesirable affect in the tuning, intonation stiffness, and long-term stability of the intonation quality of the musical instrument.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed compensation technique, in the least, corrects the instability and stiffness problems exhibited in existing guitar systems (e.g., as relate to tremolo guitar subsystems), by addressing (e.g., replacing, eliminating, etc.) the existing poorly-designed assemblies/parts, with a single fixed (or adjustable) saddle which incorporates an adjustment feature which increases string vibration of the instrument by attaining a compensated intonation formula for each string of the stringed musical instrument (e.g., guitar, electric guitar, etc.).

The innovative saddle assembly, referred to as a “wrap-around” bar (hereinafter, also, “the bar” assembly), can be secured (e.g., bolted-on, manufactured as a single piece, affixed using alternative fastener designs, etc.) to a baseplate, such as the tremolo plate, for example. The bar eliminates the instabilities created by existing attempts of lower-quality designs and inadequate design specifications of parts and assembly implementations. Utilization of curvature of the bar softens the string tones (the “feel”) by guiding strings over a larger diameter curved surface, which absorbs much of the excess string tension before the string reaches a compensation section of the bar.

In other words, the disclosed technique introduces improved stabilization and simplification in tremolo design by reducing the number of, or eliminating entirely, improperly-specified parts and/or poorly designed assemblies employed in fretted guitar designs (e.g., electric, acoustic, etc.), and other potentially applicable stringed instrument designs and systems. The existing and under-performing options of heretofore unstable and unreliable assemblies available to the consumer can now be replaced with a new and single, stable (solidly anchored) assembly, which satisfies the tuning requirement while also improving and maintaining the tone quality of the instrument.

An intonation compensation method begins with, a bridge “wrap-around” bar compatible in dimensions with a bridge of the musical instrument. String compensation locations are created on the bridge bar for each string based on intonation compensation data calculated for each string, where each string location on the bar is specific to the corresponding string compensation data. A curved surface is formed on the bridge bar to create a curved surface bridge bar, and over which each string is routed to the corresponding string location. The curved bridge bar is locked down (fixed) to a bridge baseplate to retain the intonation compensation data for each string during instrument play.

The disclosed technique ensures that all strings are simultaneously vibrating from the respective intonation compensation points. The wrap-round bar enables a far greater string contact surface than existing saddles. Once the strings rise to the abrupt angle on the back-side of the bar, the strings are guided over a large-radius curved surface at the rear portion of the bar. The bar concurrently absorbs the string tension of all the strings due to the string-bar contact over the curved portion (e.g., 3/16 inch, ¼ inch, 5/16 inch, ⅜ inch, etc.) of the length of the back-side curved surface than in any existing bridge system designs. By the string vibrations reaching the witness points (the intonation compensation points), each string tone has been softened (in contrast to stiffness intonation effects that would be present in existing systems) considerably, and the cumulative spring vibration effect (e.g., of all six strings) is applied to the wrap-around bar.

This technique provides a significantly greater contact area than standard saddles. In other words, the combined string energy of all strings (e.g., six, etc.) vibrating the bar, with no possibility of dissipation through screws and other mechanical mechanisms typically utilized in existing assemblies, enables the improved intonation effects emanating from the instrument when using the disclosed hardware and tension balancing technique(s).

The wrap-around bar can also have a minimalistic, but yet adjustable, profile (a reduced height dimension), and which further enables height adjustments on either or both of longitudinal ends of the bar. These height adjustments can translate into string height adjustments along the length of the bar, by way of set screws or other vertical adjustment mechanisms which enable the height adjustments. Additionally, the entire tremolo plate (baseplate) can be adjusted vertically (up or down). Thusly, there are multiple ways to make adjustments (e.g., forward, backward, up, down, etc.) to the baseplate only, the bar only, or both the baseplate assembly and the bar.

A tuning and tension balancing method is disclosed for a stringed musical instrument in accordance with the disclosed technique. A fretted musical instrument is received for tuning and balanced tensioning. In a first iteration of a six-string instrument, measure and set the heights equally for string three and string four. Set the height of string two to greater than height of strings three and four (e.g., no more than 0.010 inch higher). Set string height of string five lower than height of string four. Set the string height of string six lower than height of string five. Set string height of string one. Accept instrument tuning. If unacceptable, repeat the iteration at until tunning is accepted. This last step can include reducing or increasing the tension of string six, which tension affects the tension balancing of the other five strings, and then repeating the process. The height of string six typically approximates the radius of the stringboard.

In other embodiments, there is disclosed an intonation compensation system for a stringed musical instrument. The system comprises a baseplate assembly mounted on a body of the musical instrument for retaining string-ends of strings for tensioning relative to a head-end of the musical instrument; and a compensation bar affixed to the baseplate, the strings tensioned over a curved surface of the compensation bar to a tension balancing system at the head-end, the compensation bar comprises a compensation surface and a compensation point for each of the strings, the compensation surface and compensation points cause a predetermined intonation quality for each respective string of the instrument.

The compensation bar affixed to the baseplate assembly creates a single intonation compensation assembly. The compensation bar comprises a curved surface over which each of the strings wraps to contact a corresponding compensation groove. The baseplate assembly further provides accommodation for a tremolo assembly for manipulation of the string tension of each of the strings to output a desired intonation effect. Each of the strings can be adjusted according to a corresponding compensated intonation formula. The compensated intonation formula is constructed into features of the compensation bar. The compensation bar is adjustable relative to the baseplate. The optimum string lengths and tolerance differential values are determined relative to a reference octave fret. The string length tolerance ranges from about (minus) −0.0050 inches to about +0.0050 inches. The string height differential between a lowest pitch string and a highest pitch string is at most 0.0070 inches.

In yet another embodiment, an intonation compensation system is disclosed for a stringed musical instrument, comprising: a baseplate assembly mounted on a body of the musical instrument for retaining string-ends of strings for tension balancing relative to a head-end of the musical instrument; and a compensation bar affixed to the baseplate assembly to create a single intonation compensation assembly, wherein each of the strings is tensioned over a curved surface of the compensation bar and each string contacts a corresponding compensation point, the compensation surface and compensation points cause a predetermined intonation quality for each respective string of the instrument.

The baseplate assembly further provides accommodation for a tremolo assembly for manipulation of the string tension of each of the strings to output a desired intonation effect. Each of the strings is adjusted according to a corresponding compensated intonation formula. A compensated intonation formula is constructed into features of at least one of the compensation bar or the baseplate assembly. The optimum string lengths and tolerance differential values are determined relative to a reference octave fret, and string length tolerance ranges from about −0.0050 inches to about +0.0050 inches, and string height differential between a lowest pitch string and a highest pitch string is at most 0.0070 inches.

In still another embodiment, an intonation compensation method is disclosed for a stringed musical instrument. The method comprises receiving a fretted musical instrument for tuning and balanced tensioning. In a first iteration of a six-stringed instrument, measuring and setting string heights equally for string three and string four, setting height of string two to greater than both height of string three and string four, setting string height of string five less than height of string four, setting string height of string six less than height of string five, setting string height of string one, and, accepting instrument tuning. The settings (or parameters) can then be embodied in a fabricated hardware wrap-around assembly for mounting on the instrument at, for example, the bridge-end string anchor location to accommodate or not accommodate a tremolo assembly capability.

The method can further comprise setting the height of string two to no more than 0.010 inches of the heights of strings three and four. The method can further comprise ensuring string two is higher than any remaining strings, and repeating the iteration until instrument tuning is acceptable. The method can further comprise at least one of reducing string tension of string six or increasing string tension of string six to affect string tension of strings one through five, and then repeating the iteration. The method can further comprise checking string height of string six to closely approximate a radius of a stringboard of the instrument.

In yet another embodiment, an intonation method is disclosed for a stringed musical instrument. The method comprises receiving a fretted musical instrument for a compensation process of mechanical and tension balancing settings; on a wrap-around bar, establishing placement of opposing outside strings; establishing equidistant spacing between all adjacent strings based on string dimensions; identifying a highest string on the wrap-around bar and string groove locations on the wrap-around bar; installing string grooves at identified string groove locations on wrap-around bar and in alignment with corresponding strings; applying tension balancing to the strings according to tensioning settings; and securing the mechanical and tension balancing settings to the instrument.

The method can further comprise establishing the spacing based on edge-to-edge distance of diameters of adjacent strings, installing the string grooves to expose no more than one-half of a diameter of the string for that groove, identifying the highest string by including the string at least one of the string diameter or the string radius, and securing the tension settings and the wrap-around bar mechanical settings to the instrument via a wrap-wound bar assembly.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an instrument compensation assembly in accordance with the disclosed technique.

FIG. 2 illustrates an oblique close-up view of the assembly in accordance with the disclosed technique.

FIG. 3 illustrates a top-down view of the compensation assembly in accordance with the disclosed technique.

FIG. 4 illustrates an oblique view of the compensation assembly in alignment with a pickup device in accordance with the disclosed technique.

FIG. 5 illustrates an example of an intonation compensation description for a stringed musical instrument in accordance with the disclosed intonation compensation technique.

FIG. 6 illustrates an alternative baseplate for an instrument compensation assembly in accordance with the disclosed technique.

FIG. 7 illustrates an alternative intonation compensation assembly in accordance with the disclosed technique.

FIG. 8 illustrates a bottom-loading low-profile assembly for intonation compensation in accordance with the disclosed technique.

FIG. 9 illustrates a partially-exploded end-view of a wrap-around bar assembly which can be employed for intonation compensation of fretted stringed musical instruments.

FIG. 10 illustrates an intonation compensation method for a stringed musical instrument in accordance with the disclosed technique.

FIG. 11 illustrates a tension balancing method for a stringed musical instrument in accordance with the disclosed technique.

FIG. 12 illustrates a tuning and tension balancing method for a stringed musical instrument in accordance with the disclosed technique.

FIG. 13 illustrates a frontal view of the tension-balanced wrap-around bar in accordance with disclosed embodiments.

FIG. 14 illustrates is a method of establishing and installing mechanical settings of a musical instrument wrap-around bar, in accordance with a disclosed embodiment.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in diagram form in order to facilitate a description thereof. The intention is to cover all modifications, equivalents, and alternatives falling within the spirit and scope of the claimed subject matter.

The instability (e.g., lack of sustained repeatability) problems associated with traditional bridge and/or tremolo (also “trem”) assemblies are pervasive in guitar systems due to poor mechanical designs that use lower-grade screws (e.g., set screws) and improper threading, at least with respect to the stringed instrument saddles, resulting in unstable (non-repeatable) saddle height adjustment. Repeated use of the tremolo arm can cause the strings to go out of tune. Additionally, over time, the screws can loosen (unwind from the threaded screw hole) due to string vibration an instrument handling. This incremental mal-adjustment reduces the string height at the saddles, which in turn changes the tension relationship between the strings and the tremolo springs. The overall effects can be loss of tuning, increased string stiffness, and increased instability of the instrument. Moreover, the string path on existing tremolos creates a steep “angle” between the exit holes in the trem plate and the individual small diameter saddles, causing wire stiffness at the intonation point, thereby affecting the intonation quality of some or all the strings.

The disclosed innovative technique solves a widespread and long-standing instability problem (e.g., mechanical) inherent in existing and traditional tremolo devices of stringed (electric) musical instruments such as used on electric guitars. The disclosed technique enables the capability to now document and duplicate intonation points on a fixed bridge, with precision, since the disclosed technique eliminates the undesirable variables that create the instability that otherwise must be dealt with in existing systems.

The disclosed technique is an intonation compensation assembly and method for a stringed musical instrument which provides improved intonation quality and stability by defining settings parameters and then fixing the parameters into a design fabrication of a compensated wrap-around bar for installation with a tremolo bridge. The fabricated design can be made to be adjustable or nonadjustable. The fabricated assembly provides stability and simplification by eliminating and replacing multiple unstable parts with a single, repeatable, and stable part that provides repeatable string intonation qualities of the instrument as part of tuning requirements.

The disclosed technique provides an additional benefit of increased intonation quality adjustments (and settings), and sustainment (retention of the setting and thus the intonation quality of the associated string) of the tone qualities, along with reduced wire stiffness.

The disclosed technique “softens” the feel by guiding the string across a larger diameter curved surface (the wrap-around bar), which absorbs much of the excess string tension before the string reaches the intonation point. While commercially available tremolo bridges use individual adjustable saddles requiring many unstable parts, excessive set-up time, and long-term instability, the disclosed technique replaces the individual saddles with a single intonation compensated saddle, resulting in increased stability, softer feel, and improved tone.

While the disclosed technique enables benefits associated with tremolo guitar systems, the technique is also applicable to non-tremolo electric guitar bridges. Additionally, the basic concept of improving stability and tone by replacing the individual saddles with a single fixed wrap-around bar can also be applied to non-tremolo stringed musical instruments.

The wrap-around bar (also referred to shortly as a “wrap”) affixes to a baseplate, which can be the tremolo plate (a “wrap-trem” bridge) with recessed bolts underneath the tremolo plate which attach to threaded holes on the underside of the wrap-around bar. Strings can be loaded through the rear of the string block (bottom of the baseplate) and exit through the string exit holes in the baseplate. Strings are guided across the curved portion of the wrap-around bar and continue to respective grooves on the top of the wrap-around bar, which ultimately define the individual string intonation compensation points. In another view of the wrap-trem bridge, strings exit the string exit holes (also referred to herein as string-end capture holes) and are guided across the curved surface of the wrap-around bar and continue to the individual fixed intonation compensation points.

An alternative version of the disclosed technique includes the curved surface wrap-around bar, with a coarse adjustment mechanism. Coarse adjustment screws can be installed through holes in the rear of the baseplate (also referred to herein as a rear upright or upright member), and threaded into and under the curved portion of the wrap-around bar.

When the desired intonation quality has been achieved for individual, some, or all strings, the slotted wrap-around bar is locked in place (“locked down” or “fixed”) to the baseplate. This lock-down process can be accomplished by tightening two recessed lock-down screws installed in recessed slots on opposite ends of the wrap-around bar. In another example, the lock-down screws can be tightened into threaded holes of the baseplate. In yet another design, the lock-down screws can be threaded into and tightened to the bar from underneath the baseplate. In any case, a stable tremolo assembly for manipulation of string tones, pitches, height, and tension balancing enhances the long-term instrument use for tremolo and vibrato effects essential in musical instrument play.

The curvature of the bar enables the softer string tones to be consistently repeatable over time. One methodology for fixing the personalized user settings in the wrap-around bar assembly begins by documenting the current user guitar settings. This includes measuring the highest point in the current string setup (e.g., between strings 3 and 4). The string height(s) can be limited to no more than 0.010 inch. The fingerboard radius (e.g., ranging from about 7.25inches to about 16.00 inches) can then be identified: a 12.00-inch fingerboard is acceptable with tension balancing. A wrap-around bar is then fabricated to store the user intonation preferences and intonation compensation points in the bar design, and optionally, using some coarse setup adjustments. Accordingly, a user can obtain multiple bar assemblies each of which stores different user guitar configurations and intonation preferences for a same or different guitar.

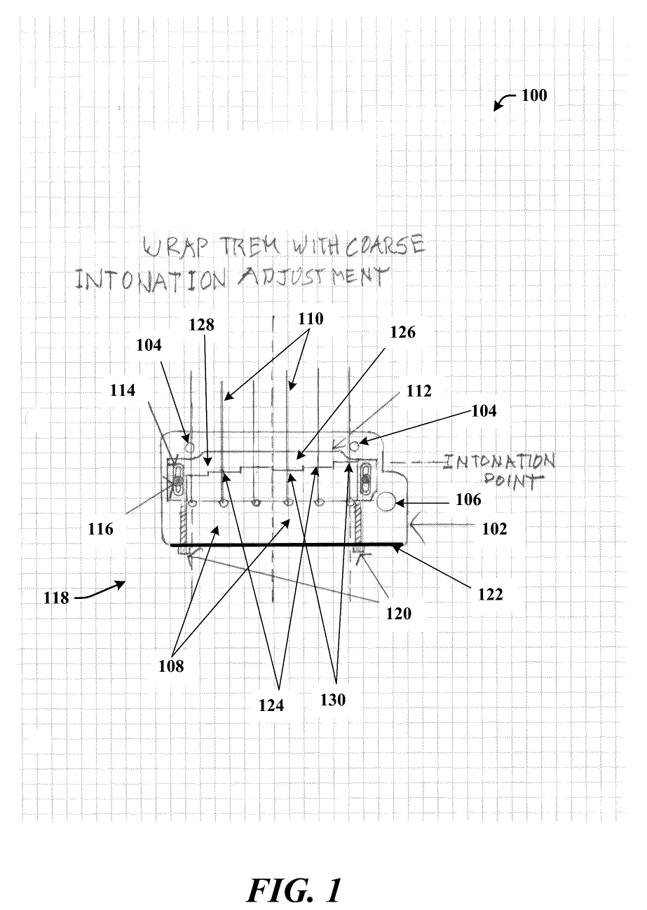

FIG. 1 illustrates an embodiment of an instrument compensation assembly 100 in accordance with the disclosed technique. The assembly 100 comprises a baseplate 102 as the foundational assembly part on which compensation parts are mounted, and from which repeatable intonation compensation adjustments can be achieved. The baseplate 102 can be a tremolo (“trem”) plate, for example, that enables tremolo effects by way of manipulation of a tremolo arm (shown below).

In this embodiment, the baseplate 102 depicts two fore-end mounting holes 104 (“fore-end” in the sense that holes 104 are closer to the front edge of the baseplate 102, which in turn is closer to the head-end of the instrument). This is in contrast to the back-end of the baseplate 102, a point on the baseplate 102 farthest from the head-end, and which additional mounting holes can be utilized to enable secure mounting of the entire assembly 100 to the instrument body. In other words, additional mounting holes can be utilized to secure the baseplate 102 at different baseplate location(s), such as the back-end corners and along the string-end holes, for example, although not illustrated here.

Moreover, the fore-end mounting holes 104 can be designed as circular slotted (screw) holes which, when the assembly 100 is to be mounted to the instrument, the fore-end holes 104 can receive and slide against two corresponding mounting screws (not shown) aligned with the fore-end holes 104. A tremolo arm hole 106 can be positioned along a side of the baseplate 102. Thereafter, the screws in the fore-end holes 104 and against which the fore-end holes 104 abutted, can be tightened down to secure the baseplate 102 and entire assembly 100 to the instrument body.

The baseplate 102 can further comprise bridge-end string anchor (or capture) holes 108 into which string ends of instrument strings 110 are captured for the tension balancing (tuning) process initiated at the head-end of the instrument using tension balancing ends (in contrast to the anchor ends) of the strings 110. When strings are installed in the holes 108, this is referred to as bottom-loading (on the base of the baseplate 102.

“Fretted” musical instruments of differing numbers of strings and frets (e.g., numbers such as 4, 5, 6, 12, etc.), such as electric guitars, pedal steel guitars, acoustic musical instruments, etc., can also obtain the benefits of the disclosed intonation compensation technique.

The assembly 100 also comprises a wrap-around bar 112 over which the instrument strings 110 are routed. In this embodiment, the wrap-around bar 112 includes at least two adjustment slots 114 (e.g., recessed) through which fasteners 116 (e.g., screws, etc.) can be inserted (and turned) to capture the bar 112 to the baseplate 102. In one embodiment, the fasteners 116 can be of a length that when sufficiently tightened (torqued), the fastener ends (e.g., screw ends) do not extend beyond the bottom surface of the baseplate 102 which lies flat against the top surface of the instrument (also referred to as the mating surface of the baseplate 102 to the instrument body).

In an alternative embodiment, the fasteners 116 (e.g., screws) can be of a length that when sufficiently tightened (torqued) and seated, the fastener ends (e.g., screw ends) do extend beyond the bottom mating surface of the baseplate 102, and thereby penetrate the instrument body surface for other purposes, such as added strength in securing the assembly 100 to the instrument, or in some way affecting the intonation compensation in a desirable way, such as to an internal mounting block (not shown) of a musical instrument soundbox (e.g., acoustic guitar).

The baseplate 102 can also accommodate a string tension coarse adjustment mechanism 118 comprised of the adjustment slots 114, slot fasteners 116, and bar adjustment screws 120 (e.g., for adjustments ranging from a fine adjustment assembly to coarse adjustment assembly, as implemented in a given assembly). The bar adjustment screws 120 can be threaded into the backside of the bar 112, such that once the slot fasteners 116 are loosened, the bar adjustment screws 120 can be turned one direction (e.g., clockwise) to increase string tension by drawing the bar 112 away from the guitar head, or turned in the opposite direction (e.g., counter clockwise) to decrease string tension by allowing the bar 112 to slide toward to the guitar head.

The adjustment screws 120 can be captured by an upward support lip (or vertical member) 122 designed into the baseplate 102, and through which the heads of the adjustments screws 120 can be captured and freely rotated such that increased and decreased tension adjustments can be achieved by drawing the bar 112 rearward away from the head-end (a tension balancing increase adjustment by increasing the distance between the compensation face to the head-end), or relaxing the bar 112 forward (toward the head-end by decreasing the distance between the head-end and the compensation face), a tension balancing reduction adjustment. Strings installed (captured) in the baseplate 102 using the string holes in the vertical member 122 are referred as being “top-loaded” strings. The baseplate 102 which includes the upright vertical member 122 can be referred to as a “hardtail” baseplate.

The wrap-around bar 112 incorporates the additional features of customized intonation compensation points 124: one compensation point for each string employed on the instrument. The compensation points 124 are enabled by designing into the bar 112 surfaces 126 (e.g., distinctively flat and stepped surfaces) on a face 128 of the bar 112, which surfaces 126 include string grooves 130 in which a respective string is rested on the way to the head-end tensioners.

The compensation points 124 define the contact points where the strings contact the respective surface string groove 130 through which the strings are tensioned (one string per groove defines the respective compensation point 124 for that string). The bar face 128 is principally perpendicular to the length dimension of the strings 110 tensioned between the body and head-end of the instrument.

In an alternative embodiment, the compensation points 124 can be enabled by any suitable construction on the bar 112. That is, rather than fabricating flat, stepped surfaces 126, the compensation points 124 can be realized using other geometric constructions such as, for example, cylinder ends of cylindrical constructions fabricated on the fore-side of the bar 112 that are then “stepped” the appropriate distance closer to or farther from the head-end of the instrument to achieve the desired intonation compensation point for the given string. Thus, string grooves 130 for guiding the appropriate strings over the bar 112 are then created on the end surfaces of the corresponding cylinders. Other shaped constructions (e.g., spherical, triangular, etc.) are within contemplation of the disclosed technique and can be employed, insofar as the constructions do not negatively impact the intonation quality of the strings and precise attainment of the intonation compensation point for each string.

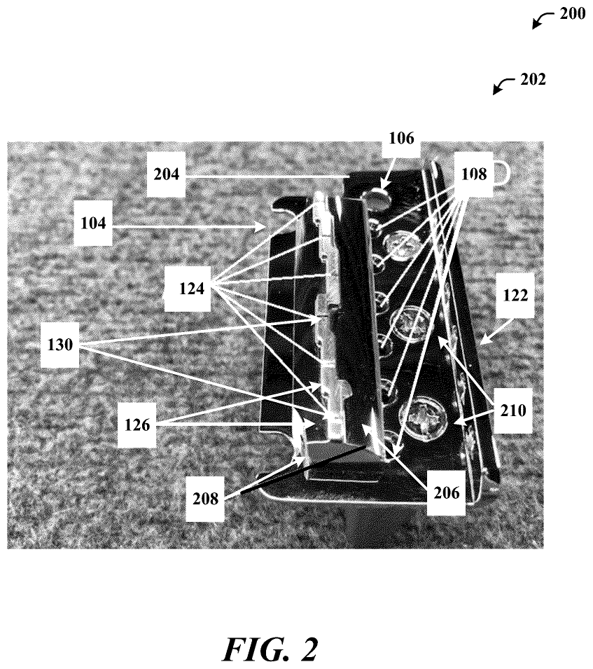

FIG. 2 illustrates an oblique close-up view 200 of an alternative embodiment assembly 202 to the assembly 100 of FIG. 1, in accordance with the disclosed technique. As shown, the alternative assembly 202 includes a baseplate 204 (also referred to as the tremolo plate), slotted baseplate circular anchor holes 104, the bridge-end string anchor holes 108 from which the respective strings can exit to and over a curved surface 206 of a wrap-around bar 208, and which strings are routed up to the respective stepped surfaces 126 to enable the customized and fixed intonation compensation points 124 for the assembly 202.

Further to this alternative embodiment, the bar 208 is secured to the baseplate 204 via the underside of the baseplate 204, where the underside surface of the baseplate 204 is the mating surface which contacts the instrument surface of the instrument body. The design for securing the bar 208 to the baseplate 204 can be two screws inserted through corresponding holes of the baseplate 204 and threading/tightening into threaded holes in the bottom of the bar 208 (not viewable).

In yet another alternative to this assembly, the baseplate 204 can include slotted screw holes in the underside of the baseplate 204, such that adjustments can be made to the bar 208 and locked-down with torqued screws. In still another feature of this alternative embodiment, there are no coarse adjustment screws operating through the vertical member 122.

Note that each of the stepped surfaces 126 contains the string groove 130 into which the corresponding string is tensioned, the points of contact of the grooves 130 and the strings 110 are collectively referred to as enabling the fixed intonation compensation points 124. Thus, six strings will typically require six respectively separate surfaces 126 created (e.g., machined, forged, hand-crafted, etc.) to retain the desired intonation compensation point 124 for each string.

As depicted in this embodiment, the baseplate 204 shows three mounting screw subassemblies 210 on the back-end of the baseplate 204. A mounting screw location is spaced between each pair of bridge-end bottom-loaded string anchor holes 108 to provide an evenly torqued and secured baseplate 204 to the instrument body. The assembly baseplate 204 also is formed with the rear or back-end upright 122 across the back-end of the baseplate 204 to facilitate top-loaded strings and provide additional material strength to eliminate any potential deformations of the assembly 202 which could otherwise introduce detrimental effects to the intonation compensation technique. The view 200 also shows the tremolo arm hole 106, through which a tremolo arm is installed to generate tremolo and vibrato effects on the musical sounds.

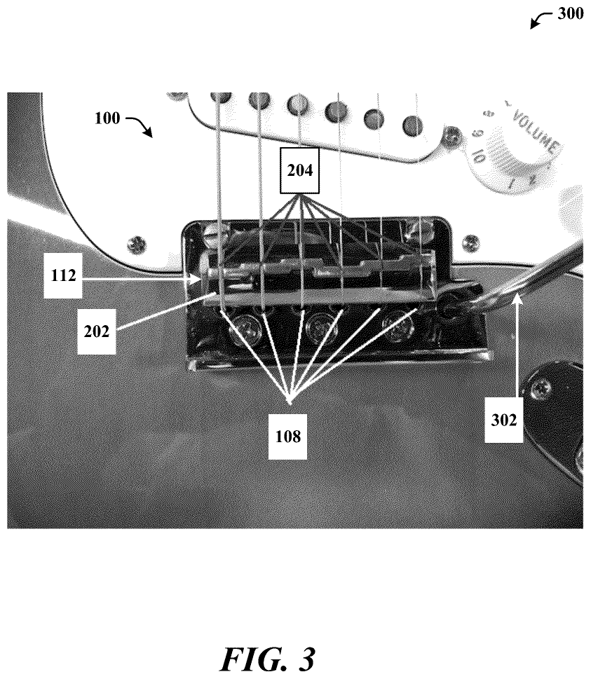

FIG. 3 illustrates a top-down view 300 of an alternative embodiment of a compensation assembly 302 in accordance with the disclosed technique. Here, the assembly 302 does not employ lock-down screws. Thus, the wrap-around bar 112 can be secured to a single position via screws attaching the bar to the baseplate from underneath the baseplate 102. As shown, the view 300 focuses on the curvature 202 of the wrap-around bar 112, the bridge-end string anchor holes 108 from which the respective strings exit to the (curved surface 202 of the bar 112) and the customized compensation points 124 for the assembly 100. Note that each of the stepped surfaces 126 contains the string groove 130 into which the corresponding string is routed laid and tensioned. Thus, six strings will typically require six separate surfaces precisely constructed (e.g., machined) to retain the desired intonation compensation for each string.

Note also that the baseplate 102 depicted here shows three mounting screws near the backend of the baseplate 102. A mounting screw location is spaced between each pair of string anchor holes 108 to provide an evenly torqued and secured baseplate 102 to the instrument body. The assembly baseplate 102 can also be formed with the rear upright or vertical member 122 across the back-end of the baseplate 102.

Note that each of the stepped surfaces 126 contains the string groove 130 into which the corresponding string is placed. Thus, six strings will typically require six separate surfaces machined to retain the desired intonation compensation for each string. A tremolo arm 302 is shown as inserted into the tremolo hole 106 to enable the user to add tremolo effects (and possibly vibrato effects) to the music being played on the instrument.

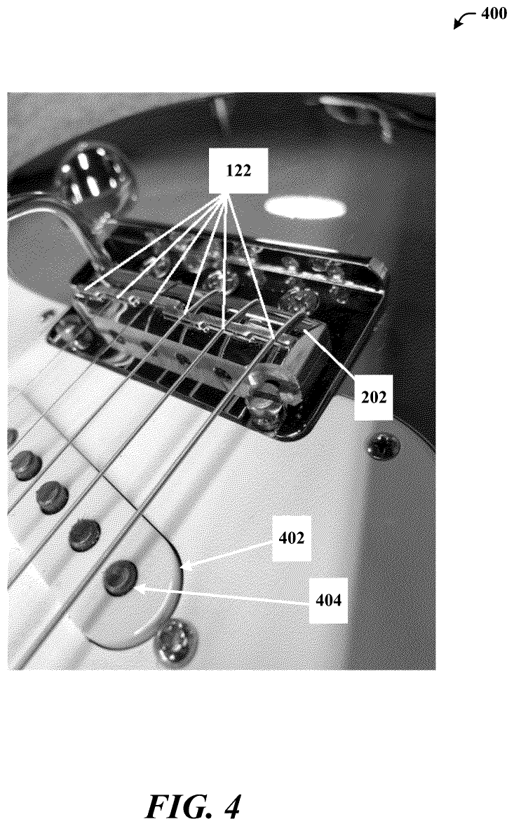

FIG. 4 illustrates an oblique view 400 of the compensation assembly 100 in alignment with a pickup device 402, in accordance with the disclosed technique. The (bridge-end holes 108, and hence, the corresponding strings) are in alignment with the pickup elements 404 of the pickup device 402. The strings are tensioned over the curved surface 202 of the bar 112, and in vertical alignment with the respective pickup elements 404 and the tensioners at the instrument head-end. The intersection of the strings and corresponding string grooves then form the intonation compensation points 124.

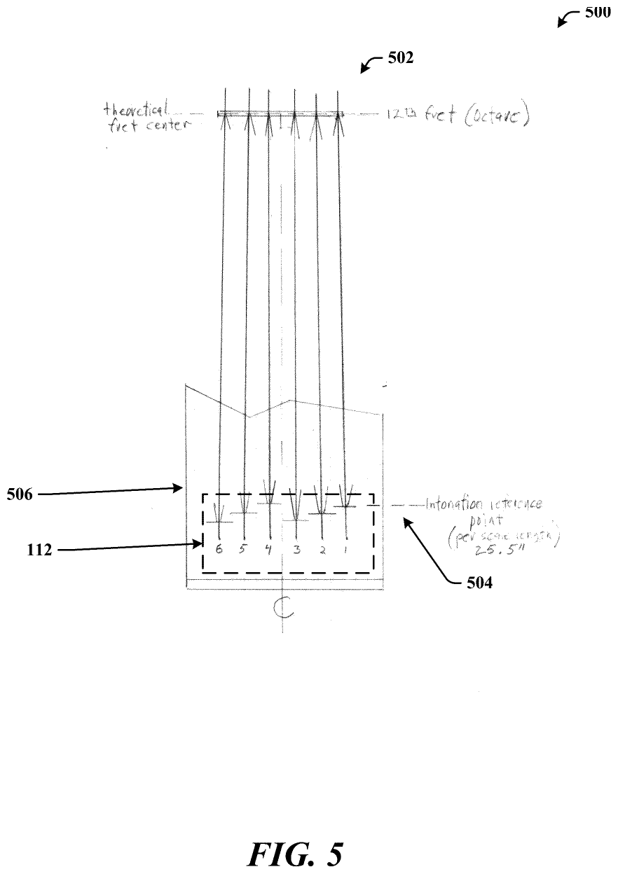

FIG. 5 illustrates one example description of an intonation compensation technique 500 for a stringed musical instrument in accordance with the disclosed intonation compensation technique. Tone(al) refers to the capability of the stringed instrument to stay in tune across different frets and strings. Intonation characteristics can be specific to the given guitar based on construction, materials, fret design, twelfth fret (e.g., size, radius, shape), etc. Moreover, the twelfth fret is at an important location on the fret board as usually being the halfway point of the string, such that harmonics can be rich and resonant, thereby providing unique intonation textures from the instrument.

Given a fretted string instrument (e.g., electric guitar), for example, the optimum string lengths and tolerance differential values can be calculated, and fixed (or secured or constructed) into that guitar via in the associated wrap-round bar. Beginning relative to some point (e.g., the center) of the reference octave fret 502 (e.g., twelfth, fourteenth, etc.), optimum string lengths for optimal intonation compensation can be determined. The twelfth fret can serve as a reference point for essential attributes of the guitar, such as tone, harmonics, and intonation characteristics, for example. In one design, string lengths relative to an intonation reference point 504 (e.g., at an instrument bridge 506, and relative to a point on the wrap-round bar) can be determined with precision. String pitch of a string can be determined with precision by comparing the string pitch of an open string (when unfretted) with the string pitch when fretted at the twelfth fret (the note octave). Thus, the twelfth fret can serve as stable reference point for the enthusiast to ensure pitch control, vibrato effects, and unique intonation textures.

When calculating potential string lengths relative to the twelfth fret and the intonation reference point 504 (relative to a per scale length of 25.5 inches, in one example), optimum string lengths can be determined, in this example, beginning on the treble string side with string one (the outside string), and ending on the bass string side with string six (the other outside string): string one −12.5000 inches, string two −12.5500 inches, string three −12.6020 inches, string four −12.5245 inches, string five −12.5660 inches, and string six −12.616 inches, with an overall +/− tolerance of 0.0050 inches.

More specifically, with respect to the tolerance of +/−0.0050 inches, and to maintain precise intonation qualities, the string one length (optimum at 12.5000 inches) can range from about 12.4950 to about 12.5050 inches, the string two length (optimum at 12.5500 inches) can range from about 12.5450 to about 12.5550 inches, the string three length (optimum at 12.6020 inches) can range from about 12.5970 to about 12.6070 inches, the string four length (optimum at 12.5245 inches) can range from about 12.5195 to about 12.5295 inches, the string five length (optimum at 12.5660 inches) can range from about 12.5610 to about 12.5710 inches, and the string six length (optimum at 12.6160 inches) can range from about 12.6110 to about 12.6210 inches.

In one implementation, to retain optimum intonation quality, the overall tolerance differential between the base and treble sides can be limited to no more than 0.0070 inches. More specifically, for example, if string one is reduced in length to 12.490 from an initial length of 12.500, this change of 0.010, needs to be reflected in the adjustment of string six to a greater length such that the overall differential between string one and string six is limited to 0.0070 inches. In other words, this minute change can become noticeable. In another embodiment, the change can be limited to 0.030, for example.

Accordingly, in one implementation, the overall string height differential between the lowest string and the highest string (e.g., the base and treble sides) is limited to no more than 0.0070 inches. In other words, the difference between string height of string one (e.g., the highest) and string six (e.g., the lowest, on a six-stringed instrument) should not exceed 0.0070 inches. In another implementation, the overall string height differential between the base and treble sides is limited to no more than 0.0065 inches. In yet another implementation, the overall differential between the base and treble sides is limited to no more than 0.0060 inches. In still another implementation, the overall differential between the base and treble sides is limited to no more than 0.0055 inches.

Fixing these values for the given instrument and strings can then be attained by design and construction of the wrap-round bar 112 specific for this given instrument. Note that the string lengths and references can differ from instrument to instrument. However, in accordance with this disclosed technique, the optimum intonation qualities can be determined and fixed in the wrap-round bar for repeatability of the initially designed intonation qualities over long term use of the instrument. It is to be understood that while the tolerances disclosed herein can be demanding, the user choice of the instrument qualities can change over time, and thus, additional and different “voiced” (specifically designed intonation qualities) wrap-round bars 112 can be designed and utilized on the given instrument by the user for the desired intonation effects.

The intonation compensation technique disclosed herein can also be applied to affect intonation characteristics based on string materials employed on the instrument such as steel, nickel, bronze, copper, and other alloys (e.g., Zamak 3, Zamak 5). The intonation compensation technique disclosed herein can also be applied to affect intonation characteristics based on string materials employed on the instrument such as string core, such as round, hexagonal, oval, twisted, and triangular core strings. The intonation compensation technique disclosed herein can also be applied to affect intonation characteristics based on string winding materials that wind around the core string. The intonation compensation technique disclosed herein can also be applied to affect intonation characteristics based on winding patterns such as round-wound strings, flat-wound strings, and half-wound strings. The intonation compensation technique disclosed herein can also be applied to affect intonation characteristics based on string wire gauge and string coatings.

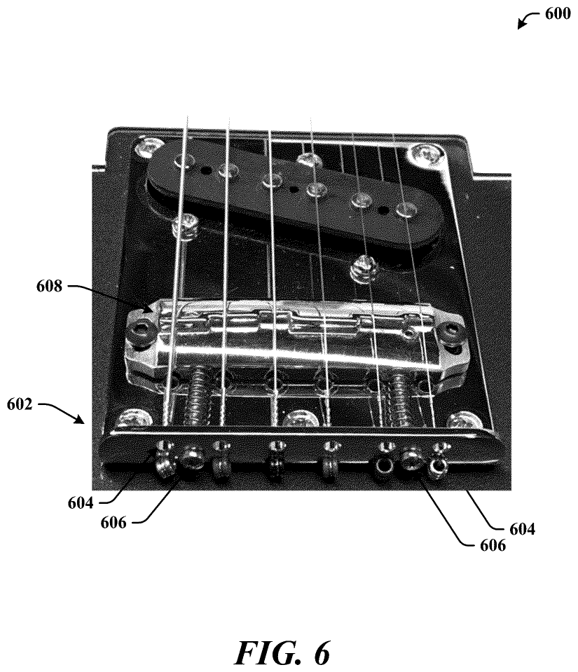

FIG. 6 illustrates an alternative (“top-loading”) baseplate embodiment 600 for an instrument compensation assembly in accordance with the disclosed technique. The alternative baseplate 600 incorporates a back-end vertical member 602 (also referred to as a “tailpiece”) with back-end top-loading string capture holes 604, and coarse adjustment objects (e.g., two screws) 606.

Here, the objects 606 are spring-loaded screws (the screw operates through the body of the spring, and between the back-end side of a wrap-round bar 608 and the fore-end side of the member 602), where turning the adjustment objects either drives the bar 608 forward toward the fore-end of the instrument, or pulls the bar 608 back toward the back-end vertical member 602.

In either case, object springs provide sufficient tension between the wrap-round bar 608 and the vertical member 602 at both object locations to retain the coarse adjustment settings during use, such as from handling and from music vibrations.

The string holes 604 in the back-end vertical upright (member) 602 provide a reversible design such that the user can return to an original saddle type design on an instrument, if desired, while retaining the bar 608 in place.

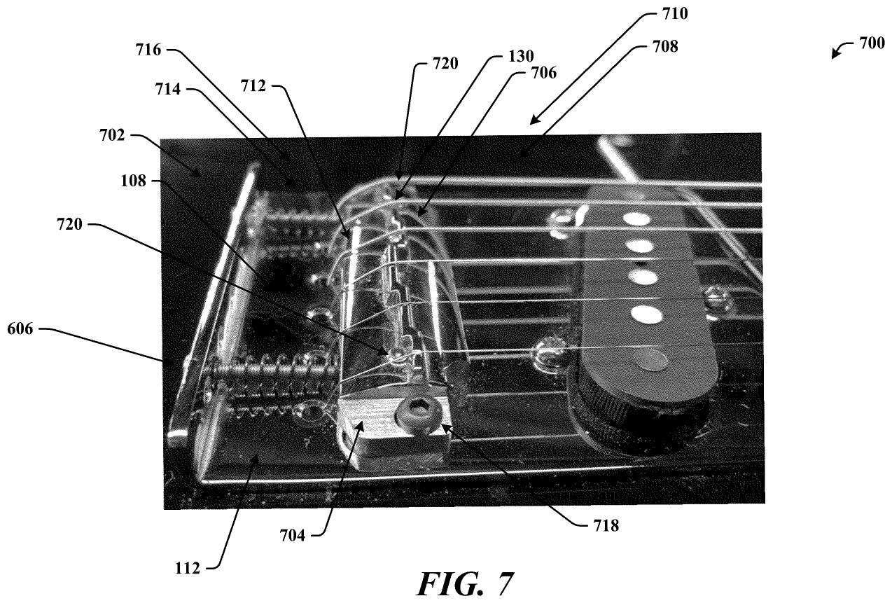

FIG. 7 illustrates an oblique view 700 of an alternative intonation compensation assembly 702 in accordance with the disclosed technique. Here, a wrap-round bar 704 includes a predominantly curved surface 706 on a fore-side 708 of the bar 704 (the fore-side 708 is the longitudinal side 710 closest to the head-end of the instrument). The wrap-around bar 704 further includes a more right-angular bend in a surface 712 on a back-side 714 of the bar 704 (the back-side 714 being the longitudinal side 716 of the bar 704 farthest from the head-end—proximate the vertical member 602 or “tailpiece”).

This example embodiment (assembly 702) is a bottom-loading string assembly on the baseplate 112 such that the strings are captured and tensioned from the baseplate holes 108 in the bottom (horizontal surface) of the baseplate 112, and extend up-and-over the gradual right-angular surface 712 of the back-side 714 of the bar 704, through the compensation point grooves 130, and then on to the head-end string tensioners. The gradual or sharpness in the bend in the gradual right-angular surface 712 can affect the “stiffness” of the string sounds. A more gradual bend or curvature reduces the stiffness in the tone of the strings, while a more defined (sharp) right-angle increases the stiffness (typically, a less desirable intonation feature).

As illustrated, the bar 704 can be adjusted forward toward the head-end, or backward away from the head-end after releasing the lock-down torque of the lock-down screws 718 (only one screw visible in this view 700) to enable the bar 704 to coarse adjust (slide) forward or backward within the screw slots of the bar 704.

Note that the backward/forward coarse adjustment of the bar 704 using the coarse adjustment screws 606, for example, can affect the string bend angle relative to the right-angular surface 712, as determined by the vertical clearance of the back-side 714 relative to the bottom-loading string holes 108. Accordingly, the lock-down hole adjustment slots 114 of the bar 704 can be designed (implemented) to limit the coarse adjustment capability of the disclosed technique while simultaneously (concurrently) enabling the user to attain the optimum intonation quality desired. Should the user want a less restrictive adjustment regime, the assembly 702 can accommodate the top-loaded string configuration thereby enabling coarse adjustment to the full extent of the adjustment slots 114.

In other words, the adjustment slots 114 can be designed with sufficient slot length to accommodate both string-loading configurations (e.g., top-loading, bottom-loading). In such a design, the user ensures that the vertical relationship of longitudinal surface of the back-side 714 of bar 704 to the string holes 108 does not generate any deleterious effects on the intonation quality.

In another embodiment, the adjustment slots 114 are designed to limit the coarse adjustment when using the bottom-loading string configuration, such that coarse adjustment is prevented from exceeding a configuration where the vertical relationship of longitudinal surface of the back-side 714 of bar 704 to the string holes 108 generates deleterious effects on the intonation quality. Thus, to obtain additional string adjustments, the user can convert to the top-loading string configuration and perform coarse adjustment using the baseplate tailpiece string configuration.

The assembly 702 also depicts one of two height adjustments screws 720 (e.g., set screws), one each located on opposite longitudinal ends of the bar 704 (only one clearly viewable). With such adjustment capabilities, a user can utilize customized bars, such as a low-height bar, a medium-height bar, and a high height bar, the customized height relative to each other, for example.

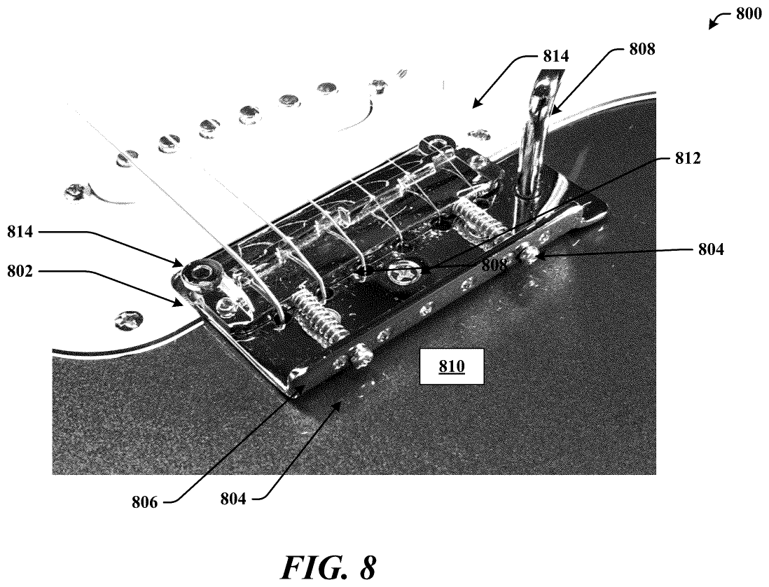

FIG. 8 illustrates a bottom-loading low-profile assembly 800 for intonation compensation in accordance with the disclosed technique. Here, as in other disclosed designs, the tremolo assembly 802 includes a bottom-load configuration with coarse adjustment screws 804 operating from the vertical member 806. A tremolo handle 808 is partially shown on the right. The assembly 800 can be mounted to the instrument body 810 using three screws 812 on the back-side (bottom-side) of the bar, and an additional two screws 814 on the fore-side of the assembly 800.

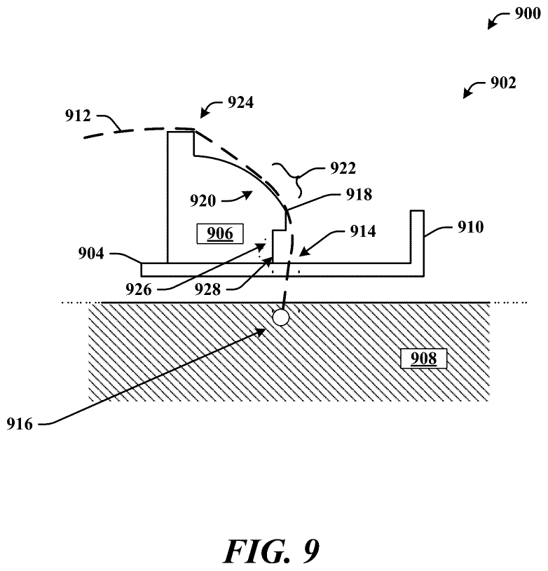

FIG. 9 illustrates a partially-exploded end-view 900 of a wrap-around bar assembly 902 which can be employed for intonation compensation of fretted stringed musical instruments. Here, the assembly 902 includes a baseplate 904 and a wrap-around bar 906. The baseplate 904 enables mounting of the assembly 902 to an underlying instrument body 908. The baseplate 904 further includes a vertical member 910 for coarse adjustments of string tension (the adjustment screws are not shown), and an optional top-loaded string configuration via the vertical member 910. As depicted, the assembly 902 is the bottom-loaded string configuration, where the strings (e.g., string 912) are routed through baseplate string holes (e.g., hole 914) and then captured by a capture mechanism 916 in the body 908 of the instrument.

As shown, the routing of the string 912 exits upward from the baseplate hole 914, over an abrupt corner 918 of the curved back-side surface 920 of the bar 904, and then maintains a contact length (CL) 922 (e.g., fractions of an inch) on the surface 920. The string 912 then continues upward to a corresponding intonation compensation point 924, which defines the optimum intonation quality for the given string 912. The string 912 then extends to the head-end to terminate to a corresponding tension balancing mechanism for tensioning (gross tension adjustment at the head-end, and a more detailed coarse adjustment at the back-end) for the optimal string intonation quality.

The bar 906 can further include angular string pathway cutouts 926 (one cutout for each string) on the bottom back-side edge 928 of the bar 906, and in alignment with each string hole, in the case where the bar 906 is fixed farther back (closer to the member 910) on the baseplate 904 such that the back-side edge 928 is partially or directly over the baseplate string hole 914. The cutout 926 then enables the string 912 to extend through the baseplate 904 and upward around the corner 918 and on to the tensioner at the head-end. The specification(s) of the compensation point 924 is then fabricated as part of the bar 906 to also incorporate the precise height for the associated string 912 needs to be relative to the reference fret and the remaining string heights.

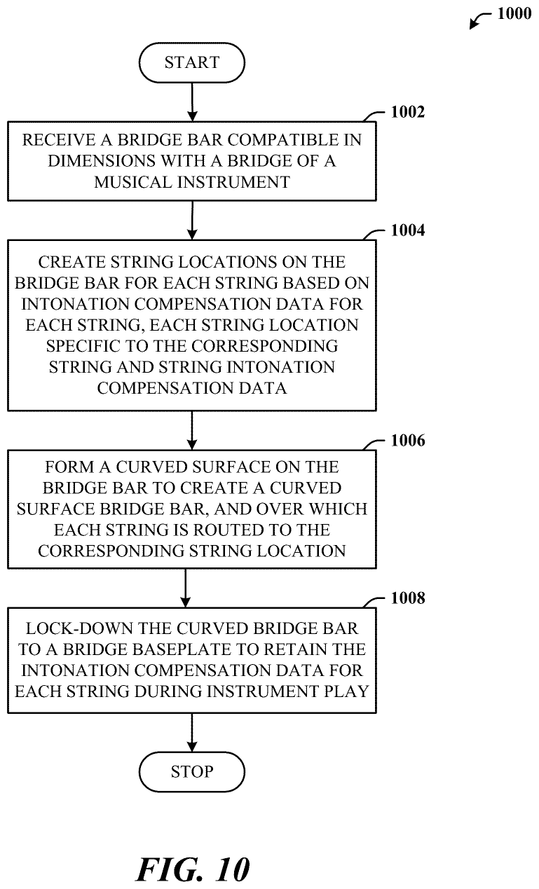

FIG. 10 illustrates an intonation compensation method 1000 for a stringed musical instrument in accordance with the disclosed technique. At 1002, a bridge bar compatible in dimensions with a bridge of the musical instrument, is received. At 1004, string locations are created on the bridge bar for each string based on intonation compensation data for each string, each string location specific to the corresponding string and string intonation compensation data. At 1006, a curved surface is formed on the bridge bar to create a curved surface bridge bar, and over which each string is routed to the corresponding string location. At 1008, the curved bridge bar is locked down to a bridge baseplate to retain the intonation compensation data for each string during instrument play.

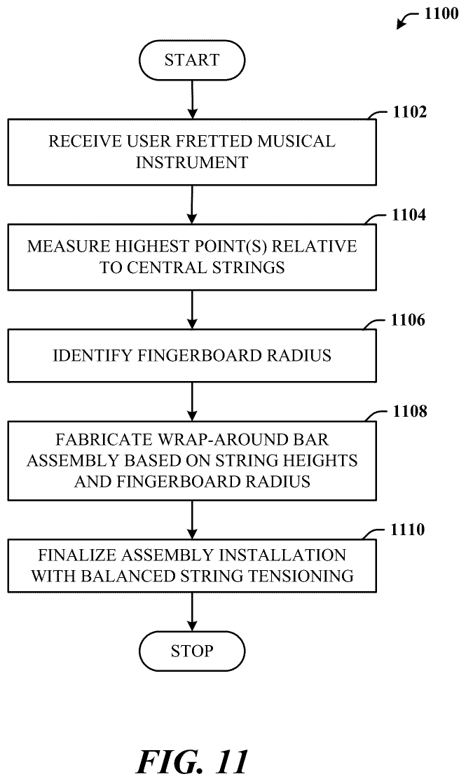

FIG. 11 illustrates a tension balancing method 1100 for a stringed musical instrument in accordance with the disclosed technique. At 1102, a user fretted instrument is received for tension balancing. At 1104, the highest points for the two central strings are measured. At 1106, the fingerboard radius is identified. At 1108, a wrap-around bar assembly is fabricated based on string heights and fingerboard radius. At 1110, the assembly installation is finalized with balanced string tensioning.

The curvature of the bar enables the softer string tones obtained according to the disclosed technique to be consistently repeatable over time. One methodology for fixing the personalized user settings in the wrap-around bar assembly begins by documenting the current user guitar settings. This includes measuring the highest point in the current string setup (e.g., between strings 3 and 4). Limit string height to no more than 0.010 inch. In another embodiment, the string height can be limited to no more than 0.020 inch. In yet another embodiment, string height can be limited to no more than 0.030 inch. In still another embodiment, the string height can be limited to no more than 0.040 inch.

The fingerboard radius (e.g., ranging from about 7.25 to about 16.00 inches) can then be identified (e.g., a 12.00-inch fingerboard is acceptable with tension balancing). A wrap-around bar is then fabricated which stores the user preferences in the bar design and some coarse setup adjustments. Accordingly, a user can obtain multiple bar assemblies each of which stores different user guitar configuration intonation preferences for a same or different guitar.

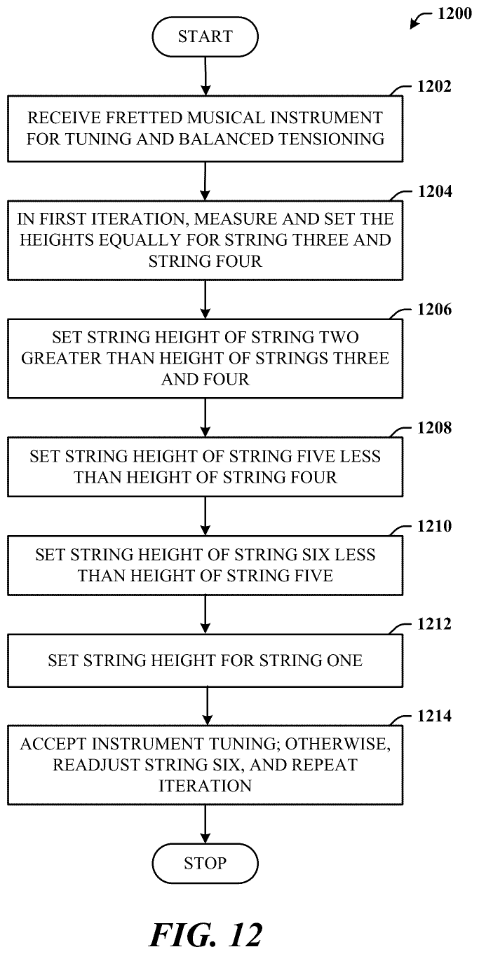

FIG. 12 illustrates a tuning and tension balancing method 1200 for a stringed musical instrument in accordance with the disclosed technique. At 1202, a fretted musical instrument is received for tuning and balanced tensioning. At 1204, in a first iteration of a six-string instrument, measure and set the heights equally for string three and string four. At 1206, set the height of string two to greater than height of strings three and four (e.g., no more than 0.010 inch higher). At 1208, set string height of string five lower than height of string four. At 1210, set string height of string six lower than height of string five. At 1212, set string height of string one. At 1214, accept instrument tuning. If unacceptable, repeat the iteration at 1204 until tunning is accepted. This last step can include reducing or increasing the tension of string six, which tension affects the tension balancing of the other five strings, and then repeating the process. The height of string six typically approximates the radius of the stringboard.

As indicated, the second (treble) string needs to be the highest of (slightly higher than) the remaining strings to attain optimum tuning and tension balancing. In other words, the strings need to be adjusted in a graduated process so that the strings are not equidistant from the top of the reference fret.

The method can further include setting the height of string two to no more than 0.010 inch of the height of string three and height of string four. The method can further comprise ensuring string two is higher than any remaining strings, and repeating the iteration until instrument tuning is deemed acceptable.

The method can further comprise adjusting (e.g., increasing or reducing) string tension of string six to affect string tension of strings one through five, and then repeating the iteration until obtaining an acceptable instrument tuning. The method can further comprise checking the string height of string six to closely approximate the radius of a stringboard of the instrument.

This innovative process does not mimic what is considered to be a “best practice” followed by most instrument tuners and designers. However, this disclosed process attains a higher quality of pitch, tension, and intonation quality. The only two strings which may be adjusted to the same height are the middle two strings, or also referred to string three and string four (of a six-stringed instrument). However, the remaining three strings (in this example) are then adjusted to different custom heights to achieve optimum tension balancing. This process does not vary from instrument to instrument.

It is to be appreciated that the design of the baseplate assembly (including the wrap-around bar) can be accomplished using automation, such as with 2D or 3D CAD (computer-aided design) software/hardware systems that enable computational changes and testing in software to achieve the desired string intonation qualities, string tension balancing, and bar features (e.g., curvature, intonation compensation points, etc.). Once completed, the final assembly parts can then be produced using the final software specifications as transmitted to and processed using metal 3D printing technologies (e.g., DMLS (direct metal laser sintering), electron beam melting, etc., see www.thomasnet.com) to create the final assembly/bar features and characteristics. CNC (computer numerical control) machines can also be employed to precisely cut and shape the parts based on the software designs suitable for the precision in making the disclosed bridge assemblies.

In yet another construction technique, in order to meet the precise string distance and height demands, lasers can be employed under software/hardware control to achieve the precise tolerances for optimal intonation quality and intonation compensation parameters.

It is also within contemplation of the disclosed technique, that the intonation qualities desired by the customer guitar can be identified and recorded in software, and then reproduced throughout the design and construction process to ensure the precise parameters imbued in the final design produces intonation qualities the user wants in the given musical instrument.

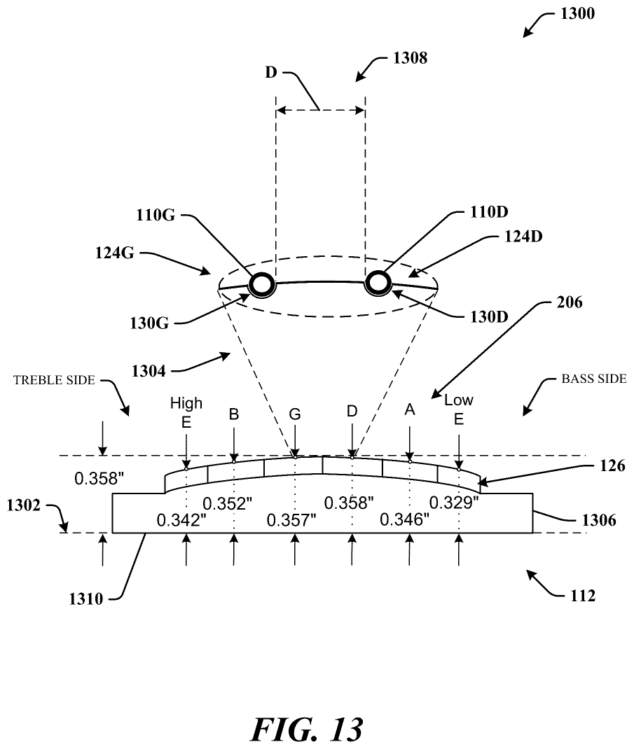

FIG. 13 illustrates a frontal view 1300 of the tension-balanced wrap-around bar 112 (see FIG. 1), in accordance with disclosed embodiments. The frontal view 1300 is the perspective along the instrument neck (also “fingerboard” or “fretboard”) from the head-end, to the top outside instrument body surface 1302 on which the wrap-around bar 112 is mounted. This specific methodology applies to various fingerboard radii, such as a fourteen-inch fingerboard radius, for example. However, the disclosed embodiment can be employed for necks of differing radii, and string sizes, tensions, and associated wrap-around bars.

This view 1300 is provided to take into consideration string thickness (horizontal diameter) and string height (vertical diameter) for the optimum instrument intonation setting, as viewed from the front face of the wrap-around bar 112. Consider the heights of the compensation points 124G and 124D for the respective G-string 110G and the D-string 110D (shown in an exploded view 1304) relative to the base 1306 of the wrap-around bar 112.

The compensation point 124D can be defined as the point of contact where the string 110D contacts (is tensioned into) a corresponding groove 130D of bar 112. For example, the compensation point 124G for the G-string 110G comprises the G-string 110G tensioned into the G-string groove 130G. Similarly, the compensation point 124D for the D-string 110D comprises the D-string 110D tensioned into the D-string groove 130D.

String grooves are also fabricated with the associated corresponding compensation points 124 (for String-High-E, String-B, String-A, and String Low-E), into which the corresponding remaining strings reside when tensioned over the curved surface 206 of the bar 112.

When determining the groove locations on the bar surface 206 for the six strings, the five distances 1308 (also distance D) (High-E to B, B to G, G to D, D to A, and A to Low-E) between the six strings are determined based on the edge-to-edge distance D of adjacent strings, where an “edge” of one string is the intersection of the diametric point on the string surface closest to the adjacent diametric point on the string surface of an adjacent string.

Given that each string incorporates a different diameter dimension, it can be desirable to ensure the edge-to-edge distances between adjacent strings, are equivalent. Thus, although the diameter of the D-string is greater than the diameter of the G-string, and the diameter of the High-E string is less than the diameter of the B-string, the distance between the D-string and the G-string, is the same as the distance between the High-E string and the B-string, and so on across the bar 112. Accordingly, the grooves are fabricated into the bar 112 based on these edge-to-edge measurements and at a suitable depth so as to not negatively affect the intonation at that compensation point.

As illustrated in FIG. 13, the wrap-around bar 112 incorporates the additional features of customized intonation compensation points 124: one compensation point for each string employed on the instrument. The compensation points 124 are enabled by designing into the bar 112, surfaces 126 (e.g., distinctively flat and stepped surfaces) on the face 128 of the bar 112, which surfaces 126 include string grooves 130 (e.g., grooves 130G and 130D) into which a respective string rests on the way to the head-end tensioners.

In this example embodiment, the overall height of the bar 112 is measured from the bottom edge 1310 of the base 1306 of the bar 112 to the highest compensation point for the D-string, is measured at 0.358 inch. This overall height of the bar 112 can change, as long as the relative heights of the strings remain the same. The disclosed mechanical design described here is applied in combination with the tension balancing methodology description above with respect to FIG. 12.

It is to be understood that any change in the overall height, even based on string thickness (vertical height of the bar 112), can change the overall performance for the instrument. In an optimum emplacement, the groove for each corresponding string, can be fabricated such that the corresponding string protrudes no more than one-half of its string diameter above the associated groove opening. In other words, by preventing lateral string movement, the groove ensures optimum intonation compensation for each string with the given overall setup of the bar 112.

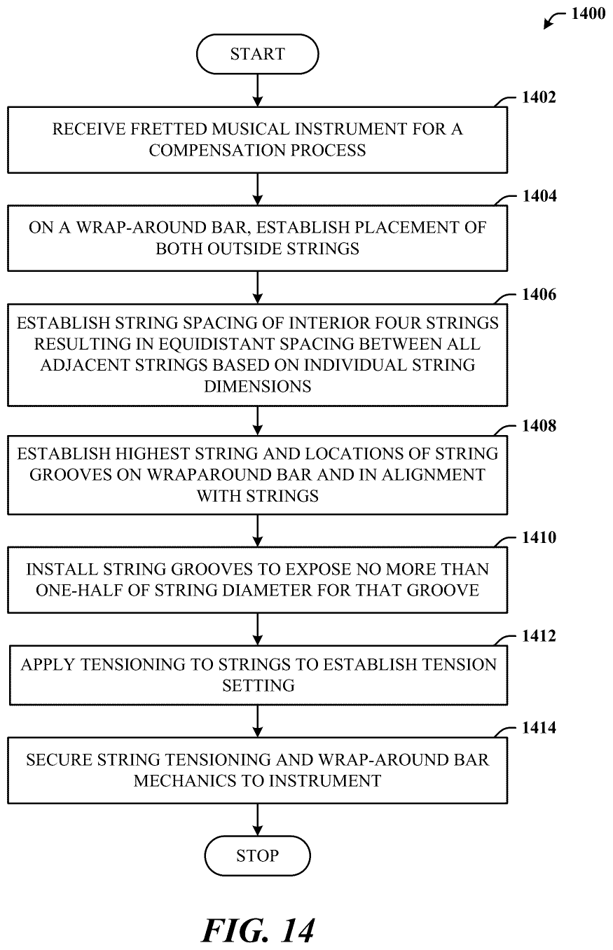

FIG. 14 illustrates is a method 1400 of establishing and installing mechanical settings of a musical instrument wrap-around bar, in accordance with a disclosed embodiment. At 1402, a fretted musical instrument is received for an intonation compensation process. At 1404, on the wrap-around bar, placement of both outside strings is established. At 1406, string spacing is established for the interior four strings, resulting in equidistant spacing between all adjacent strings based on individual string dimensions. String dimensions can include the string diameter and string radius.

In one implementation, the string spacing is established based on the edge-to-edge spacing between adjacent strings, where an “edge” of one string is the intersection of the diametric point on the string surface closest to the adjacent diametric point on the string surface of an adjacent string. Accordingly, in this embodiment, the spacing is not based on the vertical centers of the strings, but that sides (or horizontal diameter surface points) of the strings.

At 1408, the locations of string grooves on the wrap-arounds bar are established. At 1410, the string grooves are installed on the wrap-around bar (e.g., on the curved surface, a flat tensioning surface, etc.) to expose no more than one-half the string diameter for that specific groove. At 1412, string tension balancing can be applied to establish individual string tension settings. At 1414, the string tension settings and wrap-around bar mechanics are secured to the instrument via lock-down screws and bar baseplate.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An intonation compensation system for a stringed musical instrument, comprising:
a baseplate assembly mounted on a body of the musical instrument for retaining string-ends of strings for tension balancing relative to a head-end of the musical instrument; and
a compensation bar affixed to the baseplate assembly, the strings tensioned over a curved surface of the compensation bar to a tension balancing system at the head-end, the compensation bar comprises a compensation surface and a compensation point for each of the strings, the compensation surface and compensation points cause a predetermined intonation quality for each respective string of the instrument.

2. The system of claim 1, wherein the compensation bar affixed to the baseplate assembly creates a single intonation compensation assembly.

3. The system of claim 1, wherein the compensation bar comprises a curved surface over which each of the strings wraps to contact a corresponding compensation groove.

4. The system of claim 1, wherein the baseplate assembly further provides accommodation for a tremolo assembly for manipulation of the string tension of each of the strings to output a desired intonation effect.

5. The system of claim 1, wherein each of the strings is adjusted according to a corresponding compensated intonation formula.

6. The system of claim 1, wherein a compensated intonation formula is constructed into features of the compensation bar.

7. The system of claim 1, wherein the compensation bar is adjustable relative to the baseplate.

8. The system of claim 1, wherein optimum string lengths and tolerance differential values are determined relative to a reference octave fret.

9. The system of claim 8, wherein string length tolerance ranges from about −0.0050 inches to about +0.0050 inches.

10. The system of claim 8, wherein string height differential between a lowest pitch string and a highest pitch string is at most 0.0070 inches.

11. An intonation compensation system for a stringed musical instrument, comprising:
a baseplate assembly mounted on a body of the musical instrument for retaining string-ends of strings for tension balancing relative to a head-end of the musical instrument; and
a compensation bar affixed to the baseplate assembly to create a single intonation compensation assembly, wherein each of the strings is tensioned over a curved surface of the compensation bar and each string contacts a corresponding compensation point, the compensation surface and compensation points cause a predetermined intonation quality for each respective string of the instrument.

12. The system of claim 11, wherein the baseplate assembly further provides accommodation for a tremolo assembly for manipulation of the string tension of each of the strings to output a desired intonation effect.

13. The system of claim 11, wherein each of the strings is adjusted according to a corresponding compensated intonation formula.

14. The system of claim 11, wherein a compensated intonation formula is constructed into features of at least one of the compensation bar or the baseplate assembly.

15. The system of claim 11, wherein optimum string lengths and tolerance differential values are determined relative to a reference octave fret, and string length tolerance ranges from about −0.0050 inches to about +0.0050 inches, and string height differential between a lowest pitch string and a highest pitch string is at most 0.0070 inches.

16. An intonation compensation method for a stringed musical instrument, comprising:
receiving a fretted musical instrument for a compensation process of mechanical and tension balancing settings;
on a wrap-around bar, establishing placement of opposing outside strings;
establishing equidistant spacing between all adjacent strings based on string dimensions;
identifying a highest string on the wrap-around bar and string groove locations on the wrap-around bar;
installing string grooves at identified string groove locations on wrap-around bar and in alignment with corresponding strings;
applying tension balancing to the strings according to tensioning settings; and
securing the mechanical and tension balancing settings to the instrument.

17. The method of claim 16, further comprising establishing the spacing based on edge-to-edge distance of diameters of adjacent strings.

18. The method of claim 16, further comprising installing the string grooves to expose no more than one-half of a diameter of the string for that groove.

19. The method of claim 16, further comprising identifying the highest string by including the string at least one of the string diameter or the string radius.

20. The method of claim 16, further comprising securing the tension settings and the wrap-around bar mechanical settings to the instrument via a wrap-wound bar assembly.
